(19) United States
(12) Patent Application Publication
(10) Pub. No.: US 2017/0036539 A1
(43) Pub. Date: Feb. 9, 2017

(54) METHOD FOR MANAGING DIFFERENTIAL LOCK IN A MACHINE

(71) Applicant: Caterpillar Inc., Peoria, IL (US)

(72) Inventors: Justin L. Steinlage, Mackinaw, IL (US); Nathan S. Pauli, Peoria, IL (US); Jason D. Bell, Dahinda, IL (US)

(73) Assignee: Caterpillar Inc., Peoria, IL (US)

(21) Appl. No.: 15/332,904

(22) Filed: Oct. 24, 2016

(51) Int. Cl. B60K 23/04; B62D 15/02

(52) U.S. Cl. CPC B60K 23/04; B62D 15/02; B60K 2023/046

(57) ABSTRACT

A method for managing a differential lock in a machine is provided. The method receives an operator command, by a controller, for engaging the differential lock of the machine from a user input device. The method determines, by the controller, an articulation angle of the machine in response to the operator command. The method determines, by the controller, if the articulation angle exceeds a first threshold angle. The first threshold angle is based on a ground speed of the machine The method selectively prevents, by the controller, engagement of the differential lock, if the articulation angle exceeds the first threshold angle. The method provides a notification, by the controller, of the prevention of the engagement of the differential lock based on the articulation angle exceeding the first threshold angle.

### TECHNICAL FIELD

The present disclosure relates to articulated machines, and more specifically, to a method for managing a differential lock in a machine.

### BACKGROUND

Machines, such as wheel tractor scrapers, wheel loaders are provided with an articulated joint for facilitating maneuvering of the machines to execute various operations. The articulated joint allows a smaller turning radius, and therefore provides enhanced functionality. When such machines are turning on a variety of terrains, such as sand surfaces, mud surfaces, grades, side slopes, or any other uneven surfaces, it is desirable to allow driving wheels of the machines to rotate at different speeds. For example, as the machine makes a left turn, a left wheel may require fewer revolutions as compared with a right wheel.

Currently, the machines utilize a differential lock that may be selected by an operator due lack of traction on one of the driving wheels. Upon engagement of the differential lock, the driving wheels rotate at same speeds. The engagement of the differential lock may result in high shock loads in a differential assembly which may cause damage to mechanical components and further reduce life of such components. As a result, reliability of the differential assembly may be an issue that may result in breakdown of the machine.

U.S. Pat. No. 6,174,255 describes a differential lock control system for an articulated work vehicle. The articulated work vehicle is provided with a front differential and a rear differential. Both the front and rear differential are provided with differential locks which are hydraulically operated with solenoid control valves. Further, the solenoid control valves are connected to a microprocessor which calculates a predicted axle speed based on transmission output speed data received by the transmission speed sensor. The microprocessor then compares the axle speed sensor signals with an articulation angle sensor to make the differential lock release.

### SUMMARY OF THE DISCLOSURE

In one aspect of the present disclosure, a method for managing a differential lock in a machine is provided. The method receives an operator command, by a controller, for engaging the differential lock of the machine from a user input device. The method determines, by the controller, an articulation angle of the machine in response to the operator command. The method determines, by the controller, if the articulation angle exceeds a first threshold angle. The first threshold angle is calculated based on a ground speed of the machine. The method selectively prevents, by the controller, engagement of the differential lock, if the articulation angle exceeds the first threshold angle. The method provides a notification, by the controller, of the prevention of the engagement of the differential lock based on the articulation angle exceeding the first threshold angle.

Other features and aspects of this disclosure will be apparent from the following description and the accompanying drawings.

### BRIEF DESCRIPTION OF THE DRAWINGS

FIG. 1 is a side view of an exemplary machine, in accordance with the concepts of the present disclosure;

FIG. 2 is a top view of the machine of FIG. 1, in accordance with the concepts of the present disclosure;

FIG. 3 is a block diagram of a system for managing a differential lock in the machine, in accordance with the concepts of the present disclosure;

FIG. 4 is a flowchart of a method for managing the different lock in the machine, in accordance with the concepts of the present disclosure; and

FIG. 5 is a flowchart of a method for disengagement of the differential lock, while the differential lock is in an engaged condition, in accordance with the concepts of the present disclosure.

### DETAILED DESCRIPTION

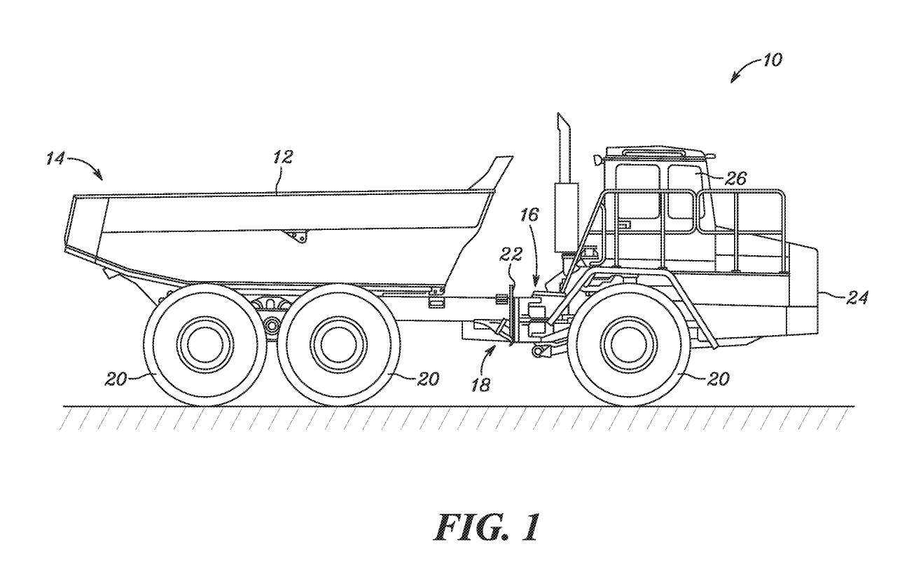

Referring to FIG. 1, an exemplary machine 10 is illustrated. The machine 10 is an articulated machine used for various operations such as, but not limited to, dumping or payload related operations. The machine 10 includes a payload carrier 12 that is disposed at a first end 14 of the machine 10. The machine 10 further has a first frame 16 and a second frame 18. Further, the machine 10 includes a number of wheels 20 which are utilized to support and maneuver the machine 10. An articulation joint assembly 22 is utilized to join the first frame 16 and the second frame 18 of the machine 10.

The machine 10 further includes an engine 24 that is configured to provide power to the machine 10 for performing various operations. Further, the machine 10 includes an operator cabin 26. The operator cabin 26 includes an operator seat (not shown) in which an operator sits and operates the machine 10. The machine 10 further includes various other components such as, but not limited to, hydraulic cylinders, wheel arches, that are not labeled in FIG. 1 for the purpose of simplicity. It will be apparent to one skilled in the art that the machine 10 shown in FIG. 1 is an articulated dump truck. However, the machine 10 may be any other machines utilizing differential arrangements such as, but not limited to, an articulated loader, an articulated wheel dozer, an articulated backhoe loader or an articulated wheel tractor scraper without departing from the scope of the disclosure.

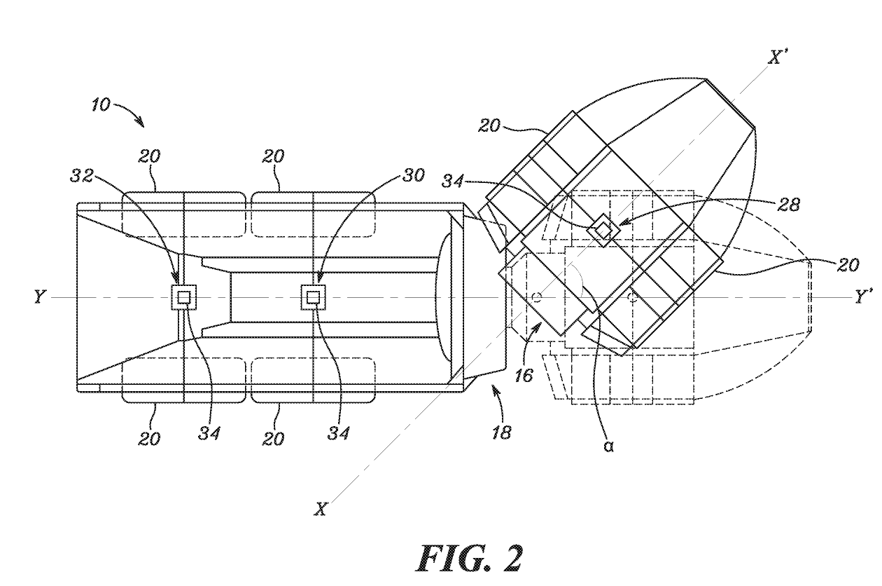

Referring to FIG. 2, the machine 10 includes a front differential assembly 28, a first rear differential assembly 30 and a second rear differential assembly 32. It will be apparent to one skilled in the art that the machine 10 may utilize any number of differential assemblies arranged in various manners without departing from the scope of the disclosure. The front differential assembly 28, the first rear differential assembly 30, and the second rear differential assembly 32 are connected by a transfer box (not shown), The transfer box is utilized to provide a distribution of a torque from the engine 24 to the front differential assembly 28, the first rear differential assembly 30 and the second rear differential assembly 32. Each of the front differential assembly 28, the first rear differential assembly 30, and the second rear differential assembly 32 may employ a differential lock 34 for each assembly to control the operations of the machine 10. The differential lock 34 may be activated by the operator due to lack of traction on one of the wheels 20 or under other conditions.

As illustrated in FIG. 2, an axis X-X′ of the first frame 16 and an axis Y-Y′ of the second frame 18 are at an articulation angle α with respect to each other. The articulation angle α of the machine 10 is defined as a relative angle between the axis X-X′ of the first frame 16 with respect to the axis Y-Y′ of the second frame 18. During straight line movement of the machine 10, the articulation angle α nearly equals to 0°. During turning operations, the articulation angle α may vary approximately between 0° to 90° depending on type of articulation required by the operator, while operating the machine 10. The machine 10 may utilize different kinds of sensors (or devices) that may be placed at different locations in the machine 10 to provide signals associated with the articulation angle α of the machine 10. It will be apparent to one skilled in the art that the articulation angle α of the machine 10 may also be calculated by other devices or mechanisms, such as, but not limited to, inertia measurement units (IMUs), or steering angle sensors, other means for measuring speed differential across left and right axles, among others without departing from the meaning and the scope of the disclosure.

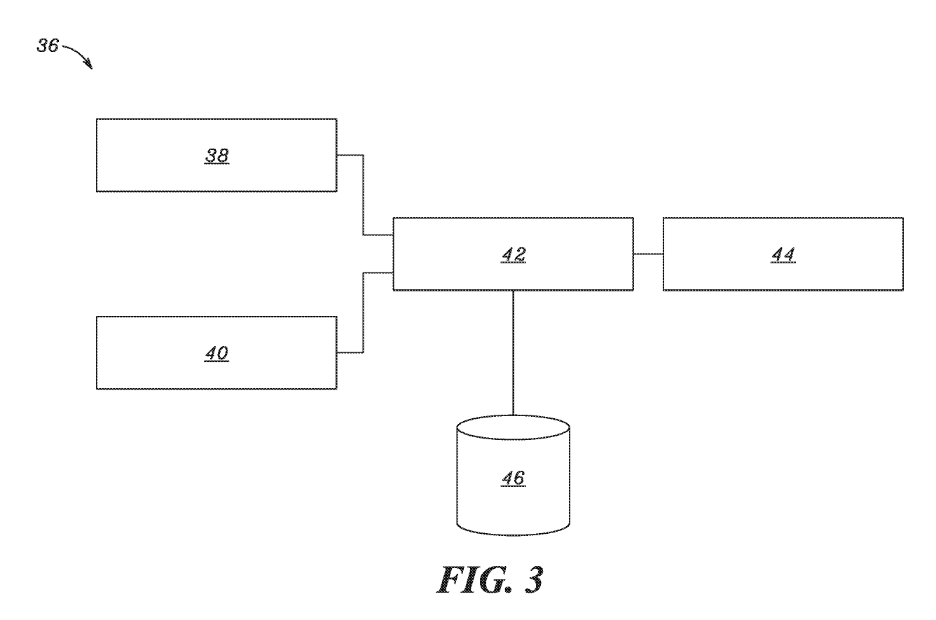

Referring to FIG. 3, a system 36 for managing the differential lock 34 of the machine 10 is provided. The system 36 includes various sensors, such as a steering angle sensor 38 and an articulation angle sensor 40 operatively coupled with a controller 42. The system 36 further includes a machine control unit 44 and a database 46. The machine control unit 44 is configured to control various aspects of the system 36, including various hydraulic components associated therewith, as well as related electrical control functions.

In a first exemplary scenario, the machine 10 is performing normal operations and the operator wishes to engage the differential lock 34 under certain conditions. The controller 42 receives an operator command from the operator for engaging the differential lock 34 using a user input device (not shown). The operator controls various operating parameters of the machine 10 by the user input device. The user input device may include a touch display device, a keyboard, a steering wheel, a joystick or other input devices.

The controller 42 calculates the articulation angle α of the machine 10 in response to the operator command. The controller 42 determines if the articulation angle α exceeds a first threshold angle. The first threshold angle may be an inhibit angle for preventing engagement of the differential lock 34 of the machine 10. The first threshold angle is a pre-defined angle calculated according to a ground speed and type of the machine 10. In an embodiment, the first threshold angle may be defined for various other types of machines and stored in the database 46. The first threshold angle may be defined on the basis of mathematical calculations, historical data and other parameters of the machine 10. The database 46 includes look-up tables for storing the first threshold angle of the machine 10. The database 46 may be any conventional or non-conventional database known in the art. In one embodiment, the database 46 may be extrinsic to the machine 10 and located at a remote location away from the machine 10, Alternatively, the database 46 may be intrinsic to the machine 10.

The controller 42 selectively prevents the engagement of the differential lock 34, if the articulation angle α exceeds the first threshold angle. The controller 42 provides a notification to the operator regarding preventing the engagement of the differential lock 34 based on the articulation angle a exceeding the first threshold angle. The operator receives a message or alarm on a user output device (not shown). The user output device may include a display device, a speaker, a monitor or other input and/or output devices. As a result, the system 36 may prevent damage to the differential assembly by preventing the engagement of the differential lock 34 under certain conditions using a proposed algorithm.

In a second exemplary scenario, the machine 10 is performing operations with the differential lock 34 in an engaged condition. The controller 42 monitors the engaged condition of the differential lock 34 in a real-time manner. On detecting the engaged condition of the differential lock 34, the controller 42 determines if the articulation angle α exceeds a second threshold angle. In an embodiment, the second threshold angle is greater than the first threshold angle. The second threshold angle is a pre-defined angle based on the ground speed and the type of the machine 10. In an embodiment, the second threshold angle may be defined for other machines and stored in the database 46. The second threshold angle may be defined on the basis of mathematical calculations, historical data and other parameters of the machine 10. The controller 42 triggers disengagement of the differential lock 34 if the articulation angle α is greater than the second threshold angle. The operator may also receive a notification or alarm about the disengagement of the differential lock 34 on the user output device (not shown).

It should be noted that the controller 42 is an electronic controller that is remotely coupled with an engine control module (ECM) of the engine 24 for carrying out various operations. The controller 42 may be a logic unit using any one or more of a processor, a microprocessor, and a microcontroller. The controller 42 may be based on an integrated circuitry, discrete components, or a combination of the two. Further, other peripheral circuitry, such as buffers, latches, switches, and the like may be implemented within the controller 42 or separately connected to the controller 42. It will be apparent to one skilled in the art that the controller 42 mentioned above may be an individual component which is in communication with other circuitries of the system 36. The controller 42 may be networked over a serial communication bus such as a controller area network (CAN) bus (not shown). Other arrangements of microcontrollers and microprocessors may be used. There may be other sensors or modules that may be connected to the controller 42 that provide the controller 42 with data for various operating conditions. The controller 42 may include a memory, a secondary storage device, a processor, and any other components for running an application. Various other circuits may be associated with the controller 42 such as power supply circuitry, signal conditioning circuitry, solenoid driver circuitry, and other types of circuitry.

### INDUSTRIAL APPLICABILITY

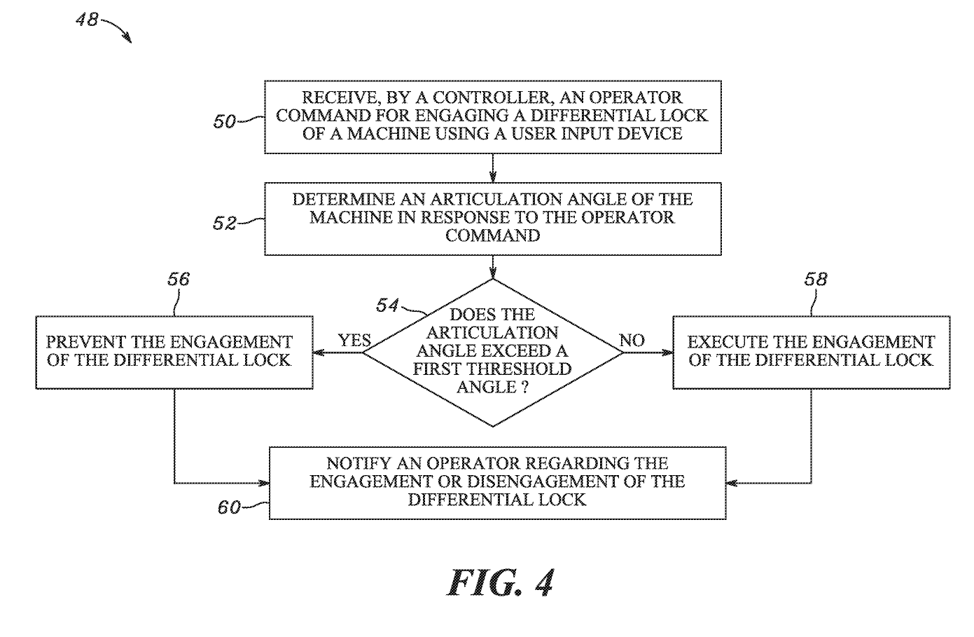

Referring to FIG. 4, a method 48 for managing the differential lock 34 in the machine 10 is described, in accordance with an embodiment of the present disclosure. The method 48 is described in conjunction with FIGS. 1 to 3.

At step 50, the controller 42 receives the operator command for engaging the differential lock 34 of the machine 10 using the user input device (not shown). At step 52, the controller 42 determines the articulation angle α of the machine 10 in response to the operator command.

At step 54, the controller 42 determines if the articulation angle exceeds the first threshold angle. If the controller 42 determines that the articulation angle exceeds the first threshold angle, the method 48 moves to step 56. Else, the method 48 moves to step 58.

At step 56, the controller 42 selectively prevents the engagement of the differential lock 34, if the articulation angle α exceeds the first threshold angle. At step 58, the controller 42 selectively executes the engagement of the differential lock 34, if the articulation angle α is lesser than the first threshold angle. At step 60, the controller 42 provides the notification to the operator of the engagement or the disengagement of the differential lock 34.

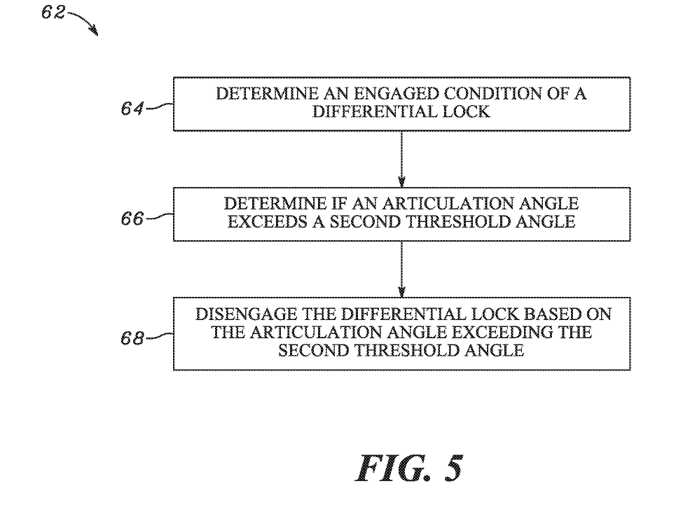

Referring to FIG. 5, a method 62 for the disengagement of the differential lock 34, while the differential lock 34 is in the engaged condition is described, in accordance with an embodiment of the present disclosure, The method 62 is described in conjunction with FIGS. 1 to 3.

At step 64, the controller 42 determines if the differential lock 34 is in the engaged condition. At step 66, on detecting the engaged condition of the differential lock 34, the controller 42 determines if the articulation angle a exceeds the second threshold angle based on the engaged condition. At step 68, the controller 42 is triggered to disengage the differential lock 34 if the articulation angle α is greater than the second threshold angle.

The proposed disclosure utilizes the controller 42 for preventing, in the real-time manner, the engagement of the differential lock 34 and therefore prevents the damage to the differential assembly. The system 36 utilizes a simple algorithm for managing the engagement and the disengagement of the differential lock 34 of the machine 10, and hence there is no requirement for additional complex systems.

The system 36 may be implemented for both front and rear differential assemblies for other work machines, such as the articulated loader, the articulated wheel dozer, the articulated backhoe loader or the articulated wheel tractor scraper and the like, The system 36 notifies the operator about the prevention of the engagement of the differential lock 34. If the differential lock 34 is in the engaged condition, the system 36 also automatically disengages the differential lock 34 based on the algorithm. As a result, the system 36 protects dog engagement gearbox assemblies, flat clutch plates, or axles, other sub-assemblies associated with the front differential assembly 28, the first rear differential assembly 30 and the second rear differential assembly 32 of the machine 10. The system 36 may offer greater reliability for managing the differential lock 34 that may result in fewer breakdowns, Further, the system 36 may allow smooth operation of the machine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for managing a differential lock in a machine, the method comprising:
receiving, by a controller, an operator command for engaging the differential lock of the machine from a user input device;
determining, by the controller, an articulation angle of the machine in response to the operator command;
determining, by the controller, if the articulation angle exceeds a first threshold angle, wherein the first threshold angle is based on a ground speed of the machine;
selectively preventing, by the controller, engagement of the differential lock if the articulation angle exceeds the first threshold angle; and
providing a notification, by the controller, of the prevention of the engagement of the differential lock based on the articulation angle exceeding the first threshold angle.

2. The method of claim 1 further comprising:
determining, by the controller, if the differential lock is in an engaged condition;
determining, by the controller, if the articulation angle exceeds a second threshold angle based on the engaged condition; wherein the second threshold angle is greater than the first threshold angle; and
triggering, by the controller, a disengagement of the differential lock based on the articulation angle exceeding the second threshold angle.
